(19) United States
(12) Patent Application Publication
(10) Pub. No.: US 2023/0128979 A1
(43) Pub. Date: Apr. 27, 2023

(54) ELECTRIC VEHICLE CHARGING STATION WITH DELIVERY CAPABILITIES

(71) Applicant: Volta Charging, LLC, San Francisco, CA (US)

(72) Inventors: Jeffrey Kinsey, San Mateo, CA (US); Ramsey Meyer, San Francisco, CA (US); Michael Clement, Monterey, CA (US); Anant Shah, San Ramon, CA (US)

(21) Appl. No.: 17/973,762

(22) Filed: Oct. 26, 2022

Related U.S. Application Data
(60) Provisional application No. 63/272,382, filed on Oct. 27, 2021.

(51) Int. Cl. B60L 53/66; B60L 53/63; B60L 53/62; B60L 58/12

(52) U.S. Cl. CPC B60L 53/66; B60L 53/63; B60L 53/62; B60L 58/12

(57) ABSTRACT

Systems and methods are provided herein for delivering items using an electric vehicle charging station (EVCS) system. The EVCS system may comprise an EVCS for charge electric vehicles. The EVCS system may also comprise a delivery vehicle removably coupled to the EVCS. The EVCS may have a compartment and/or shelf designed to house the delivery vehicle. Upon receipt of a delivery request, the delivery vehicle departs from the EVCS and transports items (e.g., batteries, charges, purchases, etc.) to one or more users.

### BACKGROUND

The present disclosure relates to computer-implemented techniques for delivering items and, in particular, to delivering items using electric vehicle charging stations (EVCSs).

### SUMMARY

As more consumers transition to electric vehicles, there is an increasing demand for EVCSs. These EVCSs usually supply electric energy, either using cables or wirelessly, to the batteries of electric vehicles. For example, a user can connect their electric vehicle via cables of an EVCS and the EVCS supplies electrical current to the user's electric vehicle. The cables and control systems of the EVCSs are typically housed in kiosks in locations to allow a driver of an electric vehicle to park the electric vehicle close to the EVCS and begin the charging process. Additionally, these EVCSs have immense power capabilities that allow them to perform multiple tasks that require high power outputs. These kiosks may be placed in areas of convenience, such as in parking lots at shopping centers, in front of commercial buildings, or in other public places. Electric vehicles are not always able to reach EVCSs due to insufficient battery charge levels. Insufficient battery charge levels can result from insufficient charging, letting the vehicle sit unused for an extended period of time, flaws in the car's charging circuit, or numerous other causes. When electric vehicles run out of charge, the electric vehicles may be towed to the nearest charging station or may be serviced by a roadside recharging truck. Although many electric vehicles provide audible and visual warnings indicating low battery charge to drivers, these warnings are sometimes missed or ignored, resulting in stranded electric vehicles. While some services for roadside charging are available, they often result in inconvenient wait times, leaving electric vehicle users stranded and forced to change their day's activities. As a result, there exists a need for an EVCS that can provide delivery of a charge to a stranded electric vehicle.

EVCSs that can provide delivery would also benefit consumers. EVCSs are typically found at locations where electric vehicle owners may wish to linger for prolonged periods, e.g., shopping centers, movie theaters, restaurants, schools, town centers, etc. For example, a user may choose to shop at a mall while their vehicle charges at an EVCS. When shopping, users are typically required to carry the items they purchase back to their electric vehicle. A user may wish to purchase more than one item (e.g., food and housewares), which may become difficult due to items that they are already carrying. Accordingly, an EVCSs with added delivery capabilities would benefit a user who purchases multiple items. As another example, some users may prefer to order items online and have those items delivered to their vehicle without entering the shopping center. However, immediate or centralized curbside pickup is not available at all stores. Accordingly, EVCSs with added delivery capabilities would benefit the users requesting curbside pickup.

Various systems and methods described herein address these problems by providing an EVCS system for delivery of items to electric vehicles. As described herein, an EVCS system for delivering items to an electric vehicle may comprise an EVCS and a delivery vehicle (e.g., a drone). The EVCS system for delivering items to an electric vehicle may also comprise a communication system, allowing the EVCS to communicate with one or more other devices (e.g., user device, electric vehicle, delivery vehicle, etc.). The communication system may have one or more connection points to facilitate communication, charging, and/or stability. For example, the connection points may be plugs, socket-outlets, vehicle connectors, and vehicle inlets using electric vehicle charging standards (e.g., International Electrotechnical Commission (IEC) 62196-1, IEC 62196-2, IEC 62196-3, IEC 62196-4, and/or IEC 62196-6). The connection points may also utilize Universal Serial Bus (USB) and/or National Electrical Manufacturers Association (NEMA) connectors and ports. For example, a first connection point (e.g., a NEMA 14-50 connector) may be configured to removably connect the EVCS to an electric vehicle. The first connection point may allow the EVCS to charge a connected electric vehicle. The EVCS system has the capability to charge delivery vehicles with or without an electric vehicle also charging using the first connection point. The first connection point may also allow the EVCS to communicate (e.g., using an ISO 15118 interface) with the connected electric vehicle. The communication system may also have a second connection point (e.g., a USB-C connector) configured to removably connect the delivery vehicle to the EVCS. The communication system may also have a transmitter and/or a receiver housed inside the EVCS kiosk, allowing the EVCS to communicate with one or more electric vehicles not connected to the EVCS.

The EVCS system for delivering items to an electric vehicle may also comprise control circuitry (e.g., microprocessors, microcontrollers, digital signal processors, programmable logic devices, etc.). The control circuitry may be located inside the EVCS kiosk. The control circuitry may be configured to facilitate the delivering of items to an electric vehicle. For example, if the EVCS receives, using the receiver, a first input (e.g., one or more data packets) from an electric vehicle not connected to the EVCS, the EVCS can process the first input. The control circuitry can be configured to determine that the first input indicates that the electric vehicle requires immediate charging. For example, if the first input includes a battery charge percentage below a certain threshold (e.g., 1%), the control circuitry can determine that the electric vehicle requires immediate charging. The control circuitry can also be configured to determine the location of the electric vehicle using the first input. For example, the first input may include location information (e.g., GPS coordinates) associated with the electric vehicle. The control circuitry can also be configured to transmit a command using the second connection point (e.g., USB-C connector) to the delivery vehicle, wherein the command indicates the location of the electric vehicle that sent the first input.

The delivery vehicle can use the location received from the EVCS to deliver a first item to the electric vehicle that sent the first input. The first item may be an item that provides a charge for the electric vehicle. For example, the first item may be a battery with a charge, a hand crank, a solar panel, etc. The delivery vehicle may have a movement system (e.g., one or more rotors, motors, batteries, wheels, etc.) used to transport the first item to the electric vehicle. The delivery vehicle may have a navigation system that uses the movement system to transport the first item to the location (e.g., GPS coordinates) of the electric vehicle. The EVCS may also notify a user of the electric vehicle about the status of the delivery vehicle. For example, the EVCS may send, using a transmitter, a notification with an estimated time of the delivery vehicle to a user device associated with the electric vehicle and/or to the electric vehicle.

In some embodiments, the delivery vehicle travels to a first location (e.g., store) in order to obtain an item. For example, a user may purchase a piece of jewelry from a store in a shopping center located near an EVCS that is charging the user's electric vehicle. The delivery vehicle may be attached to the EVCS in a method similar to what is described above. The EVCS can receive an input from the user wherein the input includes a delivery request of an item that the user purchased. The input can include an item and a location for the delivery vehicle. Once the input has been received, the EVCS transmits a command to the delivery vehicle to retrieve the item. Once the delivery vehicle returns within a threshold distance from the EVCS (e.g., two feet), the EVCS opens a compartment to store the item until the user retrieves the item. The user may then need to input a second input in order to obtain the items, e.g., a biometric scan, a barcode, a password, etc. In some embodiments, the delivery vehicle can also be used to deliver items from the user (e.g., returned purchases, credit cards, etc.) to a first location (e.g., store) using the same or similar methodologies described.

### BRIEF DESCRIPTION OF THE DRAWINGS

The below and other objects and advantages of the disclosure will be apparent upon consideration of the following detailed description, taken in conjunction with the accompanying drawings in which:

FIG. 1 shows an illustrative diagram of an EVCS system for delivering items to electric vehicles, in accordance with some embodiments of the disclosure;

FIGS. 2A and 2B illustrate embodiments of an EVCS system delivering items to electric vehicles, in accordance with some embodiments of the disclosure;

FIGS. 3A-3C illustrate an EVCS system used for charging an electric vehicle and for delivering items, in accordance with some embodiments of the disclosure;

FIG. 4 illustrates another EVCS system used for charging an electric vehicle and for delivering items, in accordance with some embodiments of the disclosure;

FIG. 5 shows an illustrative block diagram of an EVCS system, in accordance with some embodiments of the disclosure;

FIG. 6 shows an illustrative block diagram of a user equipment device system, in accordance with some embodiments of the disclosure;

FIG. 7 shows an illustrative block diagram of a server system, in accordance with some embodiments of the disclosure;

FIG. 8 shows an illustrative flowchart of a process for delivering items to an electric vehicle using an EVCS, in accordance with some embodiments of the disclosure; and

FIG. 9 depicts another illustrative flowchart of a process for delivering items to an electric vehicle using an EVCS, in accordance with some embodiments of the disclosure.

### DETAILED DESCRIPTION

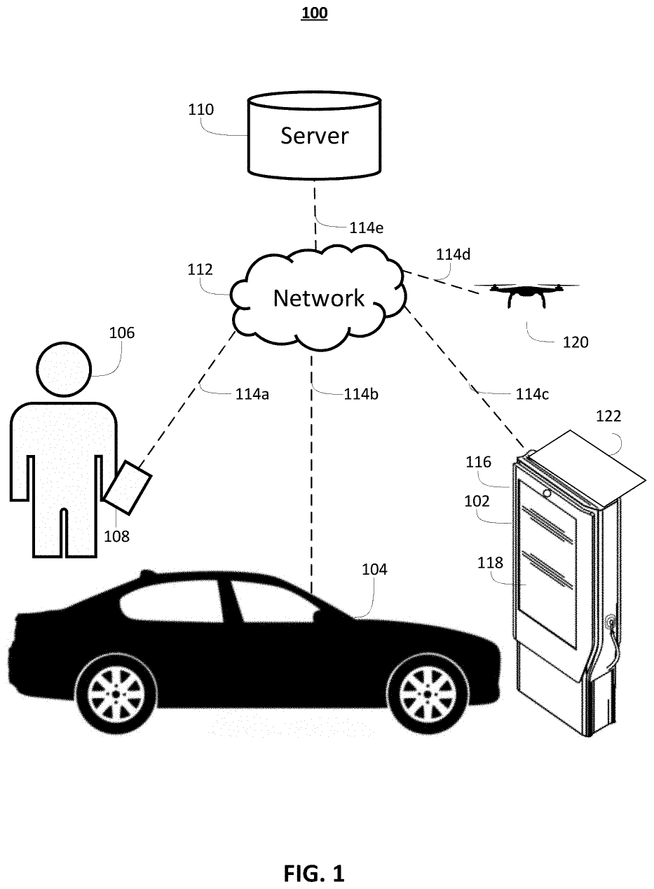

FIG. 1 shows an illustrative diagram of an EVCS system 100 for delivering items to electric vehicles 104, in accordance with some embodiments of the disclosure. In some embodiments, the EVCS 102 provides an electric charge to the electric vehicle 104 via a wired connection, such as a charging cable, or a wireless connection (e.g., wireless charging such as inductive charging from the docking station through pads). The EVCS 102 may be in communication with the electric vehicle 104 and/or a user device 108 belonging to a user 106 (e.g., a driver, passenger, owner, renter, or other operator of the electric vehicle 104) that is associated with the electric vehicle 104. In some embodiments, the EVCS 102 communicates with one or more devices or computer systems, such as user device 108 or server 110, respectively, via a network 112.

In the system 100, there can be more than one EVCS 102, electric vehicle 104, user 106, user device 108, server 110, delivery vehicle 120, and network 112, but only one of each is shown in FIG. 1 to avoid overcomplicating the drawing. In addition, a user 106 may utilize more than one type of user device 108 and more than one of each type of user device 108. In some embodiments, there are paths 114a-e between user devices, servers, EVCSs, delivery vehicles, and/or electric vehicles, so that the items communicate directly with each other via communication paths, as well as other short-range point-to-point communication paths, such as USB cables, IEEE 1394 cables, wireless paths (e.g., Bluetooth, infrared, IEEE 802-11x, etc.), or other short-range communication via wired or wireless paths. In an embodiment, the devices also communicate with each other directly through an indirect path via a communication network. The communication network may be one or more networks including the Internet, a mobile phone network, mobile voice or data network (e.g., a 4G, 5G, or LTE network), cable network, public switched telephone network, or other types of communication network or combinations of communication networks. In some embodiments, a communication network path comprises one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. In some embodiments, a communication network path is a wireless path. Communication with the devices may be provided by one or more communication paths but is shown as a single path in FIG. 1 to avoid overcomplicating the drawing.

In some embodiments, the EVCS 102 has control circuitry to control a delivery vehicle 120. The control circuitry may issue commands to a delivery vehicle 120 after receiving an input from a user 106 or a distress signal from an electric vehicle 104. In some embodiments, a removably connected delivery vehicle 120 is connected to a docking station 122. In some embodiments, the docking station 122 is connected to the EVCS 102. In some embodiments, the EVCS 102 charges both the electric vehicle 104 (e.g., via a first charging cable) and the delivery vehicle 120 (e.g., via a second charging cable) at the same time.

In some embodiments, the user 106 must present some credentials (e.g., password, pin, biometrics, device, item, etc.) when requesting the EVCS 102 to charge their electric vehicle 104. In some embodiments, the user 106 presents one or more credentials when requesting the EVCS 102 to receive the items delivered by the delivery vehicle 120. For example, the user 106 may enter a password on a display 118 of the EVCS 102. In another example, the user 106 may enter a biometric password (e.g., a fingerprint) on the user device 108 which then communicates with the EVCS 102 and/or the server 110 via the network 112. In some embodiments, the credentials are automatically inputted. For example, the user device 108 may automatically transmit user credentials to the EVCS 102 when the user device 108 is within a threshold distance of the EVCS 102 (e.g., two feet). In some embodiments, the EVCS 102 uses characteristics of the electric vehicle 104 as credentials. For example, the EVCS 102 may automatically obtain characteristics of the electric vehicle 104 using ISO 15118 when the user 106 plugs in their electric vehicle 104. In some embodiments, the EVCS 102 uses the credentials to identify a user profile associated with the user 106. For example, the EVCS 102 may access a database (e.g., located on server 110) that associates credentials with a user profile. In some embodiments, the user profile stores information about the user 106. For example, the user profile may store user information related to the user 106, vehicle information of the electric vehicle 104 related to the user 106, and/or similar such information.

In some embodiments, the EVCS 102 uses characteristics of the electric vehicle 104 to determine the user 106 associated with the electric vehicle 104. In some embodiments, the EVCS 102 uses one or more sensors to capture information about the electric vehicle 104 or the delivery vehicle 120. For example, these sensors may be image (e.g., optical) sensors (e.g., one or more cameras 116), ultrasound sensors, depth sensors, infrared (IR) cameras, red, green, blue (RGB) cameras, passive infrared (PIR) cameras, heat IR, proximity sensors, radar, tension sensors, near-field communication (NFC) sensors, and/or any combination thereof. In some embodiments, one or more cameras 116 are configured to capture one or more images of an area proximal to the EVCS 102. For example, a camera may be configured to obtain a video or capture images of an area corresponding to a parking space associated with the EVCS 102, a parking space next to the parking space of the EVCS 102, and/or walking paths (e.g., sidewalks) next to the EVCS 102. In some embodiments, the camera 116 is a wide-angle camera or a 360° camera that is configured to obtain a video or capture images of a large area proximal to the EVCS 102. In some embodiments, the camera 116 is positioned at different locations on the EVCS 102 than what is shown. In some embodiments, the camera 116 works in conjunction with other sensors. In some embodiments, the one or more sensors (e.g., camera 116) detect external objects (e.g., the delivery vehicle 120) within a region (area) proximal to the EVCS 102. In some embodiments, the one or more sensors are configured to determine a state of the area proximal to the EVCS 102. In some embodiments, the state corresponds to the presence of external objects, the lack of external objects, etc. In some embodiments, the external objects are living or nonliving, such as people, animals, vehicles, shopping carts, toys, delivery vehicle 120, etc. In some embodiments, the type of delivery vehicle 120 (e.g., an unmanned aerial vehicle or a land-roving vehicle) is determined by settings, preferences, etc., found within the profile of user 106. For example, if a user has difficulty bending over due to a medical condition, there may be accessibility controls within their profile so that only delivery vehicles that can reach compartments above a predetermined height (e.g., two feet off the ground) are used in their deliveries. In some embodiments, the EVCS 102 uses sensors to determine the presence of a delivery vehicle 120.

In some embodiments, after the one or more sensors captures information, the EVCS 102 uses this information to determine the electric vehicle 104's characteristics (e.g., model, make, specifications, condition, etc.). In some embodiments, using the data collected from the one or more sensors, the EVCS 102 identifies electric vehicle characteristics by leveraging machine learning. The EVCS 102 can use the determined electric vehicle characteristics to determine the user 106 associated with the electric vehicle 104. For example, the EVCS 102 can receive information captured by the one or more sensors (e.g., an image of the license plate) of the electric vehicle 104 from the camera 116. In some embodiments, the EVCS 102 uses optical character recognition (e.g., reads the license plate) and uses the electric vehicle characteristic (e.g., license plate information) to determine the user 106 associated with the electric vehicle 104. In some embodiments, the EVCS 102 uses a database to look up user information and/or additional vehicle characteristics of the electric vehicle 104 using the license plate information. For example, the database may comprise public records (e.g., public registration information linking license plates to vehicle characteristics), collected information (e.g., entries linking license plates to vehicle characteristics based on data inputted by a user), historic information (e.g., entries linking license plates to vehicle characteristics based on the EVCS 102 identifying vehicle characteristics related to one or more license plates in the past), and/or similar such information.

In some embodiments, the EVCS 102 uses information captured from the one or more sensors to determine vehicle characteristics of the electric vehicle 104 and/or to determine the user 106 associated with the electric vehicle 104. In some embodiments, upon connection, the EVCS 102 receives a media access control (MAC) address from the electric vehicle 104 and the EVCS 102 uses the MAC address to determine vehicle characteristics of the electric vehicle 104 and/or to determine the user 106 associated with the electric vehicle 104. In some embodiments, a MAC address associated with the delivery vehicle 120 is used to look in a database to determine the deliveries that the delivery vehicle has previously made. In some embodiments, the EVCS 102 uses the MAC address to look in the database to determine if the delivery vehicle 120 should be serviced, e.g., by determining the distance that the delivery vehicle has traveled since it has last been serviced and comparing that to the use expectations. The EVCS 102 can use a database to match a received MAC address or portions of a received MAC address to entries in the database to determine vehicle characteristics of the electric vehicle 104. For example, certain vehicle manufacturers keep portions of their produced electric vehicle's MAC addresses consistent. Accordingly, if the EVCS 102 determines that a portion of the MAC address received from the electrical vehicle 104 corresponds to an electric vehicle manufacturer, the EVCS 102 can determine vehicle characteristics of the electric vehicle 104. The EVCS 102 can also use a database to match the received MAC address or portions of the received MAC address to entries in the database to determine the user 106 associated with the electric vehicle 104. For example, the electric vehicle's MAC address may correspond to a user profile corresponding to the user 106 associated with the electric vehicle 104.

In some embodiments, the EVCS 102 uses user information to determine vehicle characteristics of the electric vehicle 104. For example, the user 106 may input vehicle characteristics into a profile that is accessible by the EVCS 102. In some embodiments, when the EVCS 102 determines that the user 106 is charging their electric vehicle 104, the EVCS 102 receives vehicle characteristics associated with the electric vehicle 104 from a profile associated with the user 106. In some embodiments, based on a profile for the user 106, a specific delivery is suggested to the user. For example, if the user has recently purchased an item from a location that is near the EVCS 102, the EVCS 102 may suggest delivering the item again. In another example, if the user 106 typically purchases an item from a coffee shop when at the EVCS 102, the EVCS 102 may suggest an item from the coffee shop via the delivery vehicle 120.

In some embodiments, the EVCS 102 is removably connected to the delivery vehicle 120. In some embodiments, delivery vehicle 120 is, e.g., an unmanned aerial vehicle, a land-roving vehicle, etc. In some embodiments, the delivery vehicle 120 delivers a portable charge to stranded electric vehicles, e.g., vehicles with a charge of less than 1%. In some embodiments, the delivery vehicle 120 and/or the portable charge is charged by circuitry within the EVCS 102. In some embodiments, a delivery vehicle 120 retrieves and delivers items from a location near the EVCS 102 (e.g., a shopping center, a store, a warehouse). In some embodiments, the EVCS 102 includes a compartment to hold items the delivery vehicle 120 carries or obtains during deliveries/retrievals.

In some embodiments, the delivery vehicle 120 is removably connected to the EVCS 102 via the docking station 122. The docking station 122 may take different forms based on the design of the EVCS 102. In some embodiments, the docking station 122 is included during the initial installation of the EVCS 102. In some embodiments, the docking station 122 is added after the initial installation of the EVCS 102. The addition of the docking station 122 may require tools (e.g., nails, solder, plastic, bolts, screws, etc.) to stabilize and/or connect the docking station 122 to the EVCS 102.

In some embodiments, the display 118 displays the location of the delivery vehicle 120. In some embodiments, the display 118 indicates that the delivery vehicle 120 is in the process of helping a stranded electric vehicle. In some embodiments, the display 118 indicates that while the parking space may be unoccupied, the delivery vehicle 120 is to return with an electric vehicle in need of the EVCS 102. In some embodiments, the user 106 interacts with the display 118 in order to utilize the different capabilities of the EVCS 102. For example, the user 106 may need to interact directly with the display 118 in order to start charging their electric vehicle 104, to return the delivery vehicle 120, to obtain items retrieved by the delivery vehicle 120, etc.

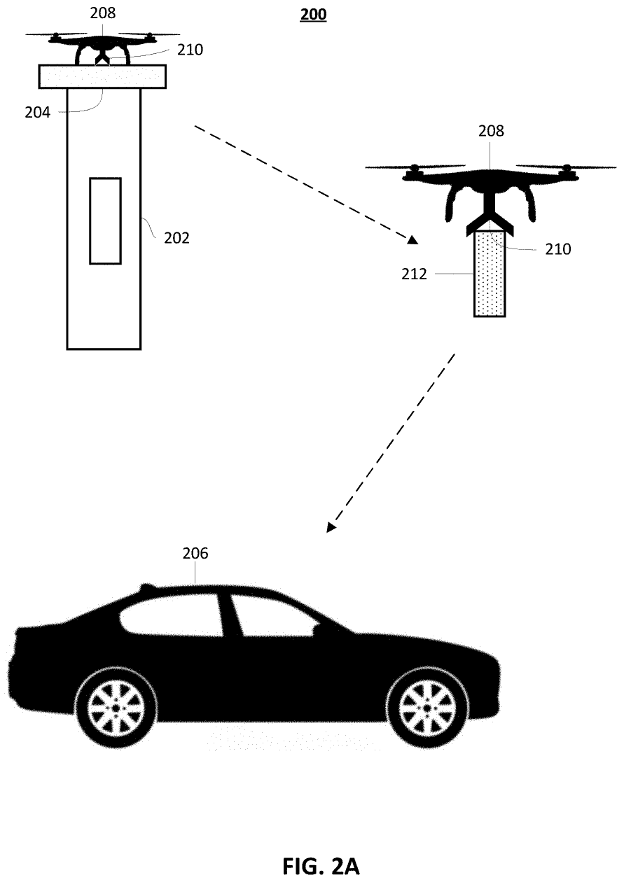

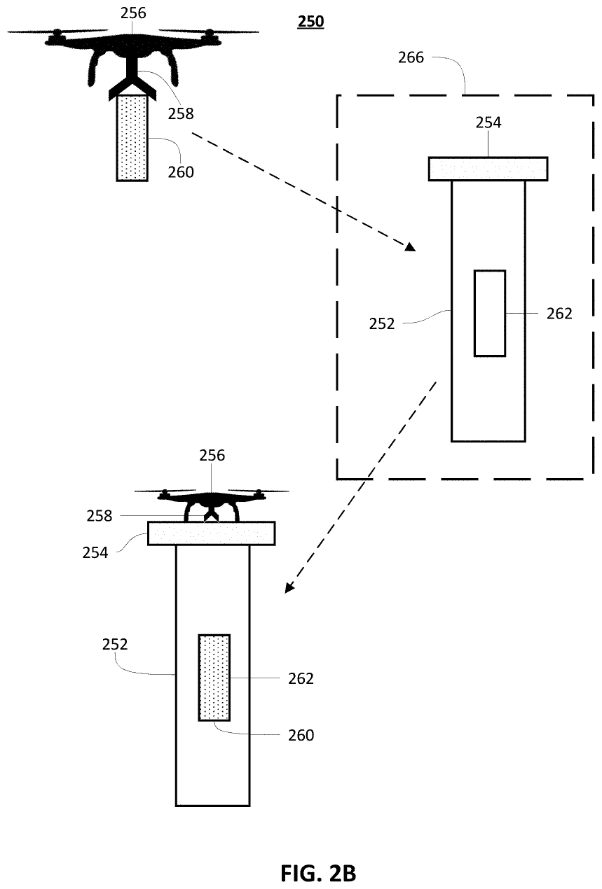

FIG. 2A illustrates an embodiment of a system 200 delivering items to an electric vehicle 206, in accordance with some embodiments of the disclosure. FIG. 2A includes an EVCS 202 with the capability to deliver a portable charge 212 to the electric vehicle 206. In some embodiments, a delivery vehicle 208 is docked on a docking station 204. In some embodiments, the delivery vehicle 208 takes the form of an unmanned aerial vehicle and/or a land-roving vehicle that is connected via the docking station 204 to the EVCS 202 (e.g., wirelessly or via wires).

In some embodiments, the electric vehicle 206 sends a distress signal to the EVCS 202 if the electric vehicle's battery falls below a predetermined threshold level of charge (e.g., 1%). In some embodiments, the electric vehicle 206 sends the distress signal automatically. In some embodiments, the user of the electric vehicle 206 sends the distress signal to the EVCS 202. In some embodiments, the electric vehicle 206 loses power, leaving the user (e.g., user 106 from FIG. 1) stranded. In some embodiments, electric vehicle 206 will still be drivable but still sends a signal requesting the EVCS 202 to deliver a portable charge 212. In some embodiments, upon receiving the distress signal, the EVCS 202 determines if the electric vehicle 206 falls within a predetermined distance range (e.g., four miles) from the EVCS 202. If the electric vehicle 206 is within the predetermined range, the EVCS 202 sends the electric vehicle 206 a portable charge 212 via the delivery vehicle 208 which has a gripper 210. In some embodiments, the distress signal includes the location of the stranded electric vehicle 206. In some embodiments, the EVCS notifies a user of the electric vehicle 206 about the status of the delivery vehicle 208 e.g., including delivery vehicle location (e.g., delivery vehicle coordinates), delivery vehicle type, delivery vehicle estimated arrival time, etc.

The delivery vehicle 208 may have a movement system (e.g., one or more rotors, motors, batteries, wheels, etc.) used to transport the portable charge 212 to the electric vehicle 206. In some embodiments, the delivery vehicle 208 has a navigation system, which uses the movement system to transport the portable charge 212 to the location (e.g., GPS coordinates) of the electric vehicle 206. In some embodiments, the electric vehicle 206 returns to the EVCS 202 with the delivery vehicle 208 once the electric vehicle 206 has charged to a certain threshold (e.g., enough for the electric vehicle to travel to the EVCS 202). In some embodiments, the delivery vehicle 208 uses the movement system to return to the EVCS 202. In some embodiments, the delivery vehicle 206 returns the portable charge 212 to the EVCS upon returning from the electric vehicle 206. In some embodiments, the electric vehicle 206 transports the delivery vehicle 208 to the EVCS 202 after receiving the portable charge 212.

In some embodiments, the delivery vehicle 208 has the mechanical gripper 210 affixed to the delivery vehicle 208, which carries the portable charge 212. The gripper 210 of the delivery vehicle 208 may carry the portable charge 212, e.g., by holding the portable charge 212 directly, by connecting to the portable charge 212 via a cable or other locking mechanism by connecting to a chamber that can carry the portable charge 212 (e.g., a cage feature), etc. In some embodiments, the portable charge 212 is removably connected to the delivery vehicle 208 such that a gripper may not be necessary.

In some embodiments, the portable charge 212 is a battery with a charge, a hand crank, a solar panel, etc. The portable charge 212 may vary in size. In some embodiments, the size of a portable charge 212 corresponds to the need of the electric vehicle 206 as determined by the EVCS 202. A portable charge 212 may connect to the electric vehicle in varying ways, e.g., wirelessly or via a wired connection. In some embodiments, the portable charge 212 is capable of multiple uses for multiple electric vehicles. In some embodiments, the portable charge 212 is only capable of a single charge. In some embodiments, the portable charge 212 is available for purchase by the user of the electric vehicle 206. In some embodiments, the EVCS 202 can charge the portable charge 212. In some embodiments, the EVCS 202 charges the portable charge 212 via a wireless or wired connection to the EVCS 202. In some embodiments, the portable charge is a part of the delivery vehicle 208.

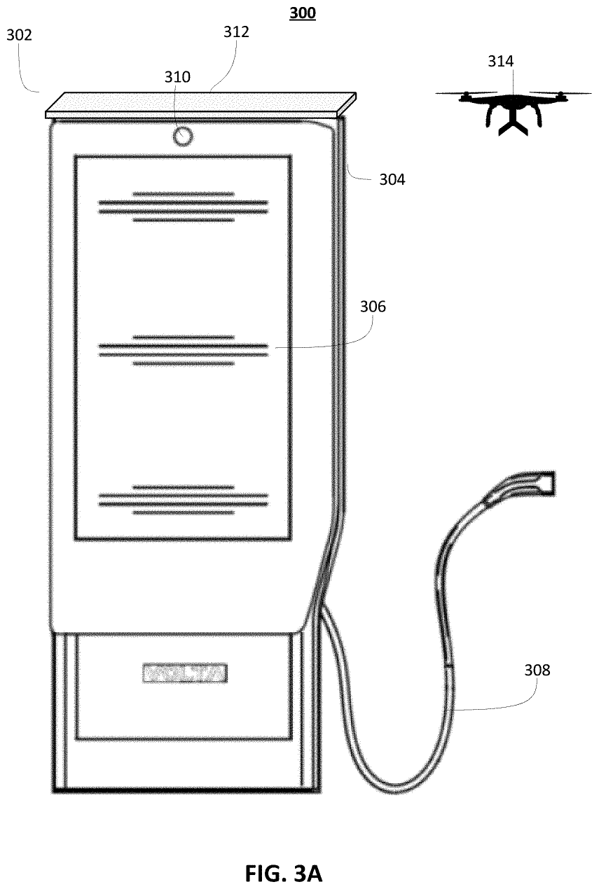

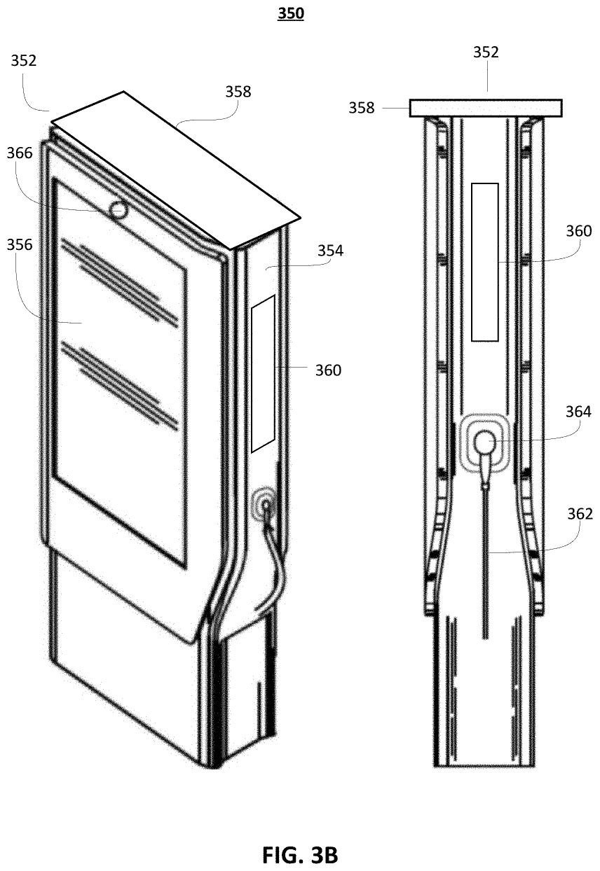

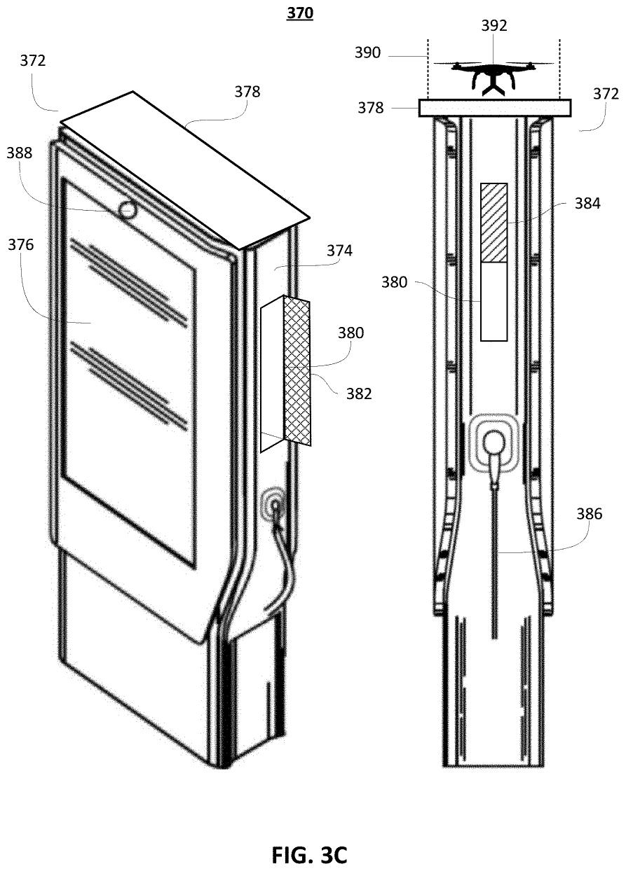

FIG. 2B illustrates an embodiment of a system 250 delivering items to an electric vehicle, in accordance with some embodiments of the disclosure. FIG. 2B comprises an EVCS 252 and a delivery vehicle 256 with a gripper 258. In some embodiments, the EVCS 252 comprises a docking station 254 and an empty compartment 262 as described in FIGS. 3B and 3C below. In some embodiments, the EVCS 252 instructs the delivery vehicle 256 to retrieve an item 260 from a location. In some embodiments, the instruction is based on a user request (e.g., purchase order). In some embodiments, the EVCS 252 can send a notification to the location (e.g., store) indicating that a user has requested the item 260. In some embodiments, the notification is sent from an electric vehicle associated with the user to the EVCS 252 and/or to the location. In some embodiments, the notification is sent from a server to the EVCS 252 and/or to the location, in response to a user request. In some embodiments, the notification indicates when the user will arrive at the EVCS 252 to receive the item 260. In some embodiments, the notification includes user information. For example, the notification can include the trip status of an electric vehicle associated with the user, indicating that a user is a certain distance and/or time from the EVCS 252. In some embodiments, additional notifications are generated. For example, if a car accident occurs on the route used by the user when traveling to the EVCS 252, an additional notification may be generated indicating the change in arrival time. In another example, when the user plugs their electric vehicle into the EVCS 252, an additional notification may be generated indicating that the user has arrived at the EVCS 252.

In some embodiments, the notification includes delivery information. The notification may indicate that the user will be at the EVCS 252 to pick up the item 260 at a first time period (e.g., 15 minutes). In some embodiments, the EVCS 252 and the location use this information to optimize the delivery process. For example, the notification can indicate that the user is going to arrive at the EVCS 252 in 15 minutes and that the delivery vehicle 256 takes five minutes to travel to and from the location and the EVCS 252. Accordingly, the notification can indicate to the location that the item should be ready five minutes before the user arrives at the EVCS 252, so that the delivery vehicle 256 can pick up the item 260 from the location and travel from the location to the EVCS 252 before the user arrives at the EVCS 252. In some embodiments, the delivery vehicle 256 delivers the item 260 to the compartment 262 around the same time (e.g., within five minutes) as the user's arrival. In some embodiments, the item delivery is dependent on the type of item. For example, a perishable item may be delivered to the EVCS 252 closer to the user's arrival at the EVCS 252, and a non-perishable item may be delivered to the EVCS 252 well before (e.g., one hour) the user arrives at the EVCS 252.

In some embodiments, there is a landing area where delivery vehicle 256 may retrieve the items. For example, the landing area may be designated counter space at the location where items are being retrieved. An employee in the location where the delivery vehicle 256 is retrieving the item 260 may interact directly with the delivery vehicle 256 in order to secure the item 260 for delivery. For example, a salesclerk may directly put the purchased item into the gripper 258.

When the docking station 254 is empty, the EVCS 252 may monitor a threshold distance 266. The threshold distance 266 may correspond to an area around the EVCS. The threshold distance 266 may help determine if/when to open the compartment 262. In some embodiments, the threshold distance 266 varies in size. In some embodiments, in order to determine if the delivery vehicle 256 has come within the monitored threshold distance 266, sensors are used. For example, these sensors may be image (e.g., optical) sensors, sensors (e.g., one or more cameras), ultrasound sensors, depth sensors, IR cameras, RGB cameras, PIR cameras, heat IR, proximity sensors, radar, tension sensors, NFC sensors, and/or any combination thereof In some embodiments, once the delivery vehicle 256 is within the threshold distance 266, the compartment 262 opens to store the item 260.

In some embodiments, once the compartment 262 is open, the delivery vehicle 256 deposits the item 260 into the compartment 262. In some embodiments, once the item 260 is placed in the compartment 262, the compartment 262 closes. In some embodiments, the compartment 262 locks upon receiving the item. In some embodiments, the EVCS 252 requires a second input from the user to open the compartment 262 (e.g., a passcode, a button press, a QR or barcode on their mobile device, biometrics, etc.).

In some embodiments, once the delivery vehicle 256 places the item 260 into the compartment 262, the delivery vehicle 256 returns to the docking station 254. In some embodiments, upon its return, the delivery vehicle 256 reconnects to the docking station 254 and begins charging. The gripper 258 may retract once the delivery vehicle 256 returns to the docking station 254.

FIG. 3A illustrates a system 300 used for charging an electric vehicle and for delivering items, in accordance with some embodiments of the disclosure. In some embodiments, FIG. 3A illustrates the EVCS 102 displayed in FIG. 1. The EVCS 302 includes a housing 304 (e.g., a body or a chassis) that holds a display 306. In some embodiments, the EVCS 302 comprises more than one display. For example, the EVCS 302 may have a first display 306 and a second display (on the other side of the EVCS 302). In some embodiments, the display 306 is large compared to the housing 304 (e.g., 60% or more of the height of the frame and 80% or more of the width of the frame), allowing the display 306 to function as a billboard, capable of conveying information to passersby. In some embodiments, the one or more displays 306 display messages (e.g., media items) to users of the EVCS 302 (e.g., operators of the electric vehicles) and/or to passersby that are in proximity to the EVCS 302. In some embodiments, the display 306 has a height that is at least three feet and a width that is at least two feet.

The EVCS 302 further comprises a computer that includes one or more processors and memory. In some embodiments, the memory stores instructions for displaying content on the display 306. In some embodiments, the computer is disposed inside the housing 304. In some embodiments, the computer is mounted on a panel that connects (e.g., mounts) a first display (e.g., a display 306) to the housing 304. In some embodiments, the computer includes an NFC system that is configured to interact with a user's device (e.g., user device 108 of a user 106 in FIG. 1).

In some embodiments, a docking station 312 is installed by connecting the docking station 312 to the EVCS 302. One or more docking stations 312 may be mounted directly on the housing 304 of the EVCS 302 and may have a physical (e.g., electrical, wired) connection to the EVCS 302. In some embodiments, the docking station 312 is part of the housing 304. In some embodiments, the docking station 312 is attached to the bottom of the EVCS 302. In some embodiments, the docking station 312 is located within the EVCS 302. In some embodiments, the display 306 shows the location of a delivery vehicle 314.

The EVCS 302 further comprises a charging cable 308 (e.g., connector) configured to connect and provide a charge to an electric vehicle (e.g., electric vehicle 104 of FIG. 1). In some embodiments, the charging cable 308 is an IEC 62196 type-2 connector. In some embodiments, the charging cable 308 is a “gun-type” connector (e.g., a charge gun) that, when not in use, sits in a holder (e.g., a holster). In some embodiments, the housing 304 houses circuitry for charging an electric vehicle. In some embodiments, the housing 304 houses circuitry for charging the delivery vehicle 314. In some embodiments, the housing 304 includes power-supply circuitry as well as circuitry for determining a state of a vehicle (e.g., a delivery vehicle, an electric vehicle) being charged (e.g., whether the vehicle is connected via the connector, whether the vehicle is charging, whether the vehicle is done charging, etc.). In some embodiments, the EVCS 302 supports ISO 15118, which allows a user to plug their electric vehicle into the EVCS 302 and begin charging without inputting any additional information. ISO 15118 is a communication interface, which, among other things, can identify the make and model of an electric vehicle to an EVCS. When an electrical vehicle that supports ISO 15118 begins charging, the EVCS 302 can receive vehicle characteristics (e.g., make and model of the electric vehicle) using ISO 15118.

The EVCS 302 further comprises one or more cameras 310 configured to capture one or more images of an area proximal to the EVCS 302. In some embodiments, the one or more cameras 310 are configured to obtain video of an area proximal to the EVCS 302. For example, a camera may be configured to obtain a video or capture images of an area corresponding to a parking space associated with the EVCS 302. In another example, another camera may be configured to obtain a video or capture images of an area corresponding to a parking space next to the parking space of the EVCS 302. In some embodiments, a camera 310 is used to determine the location and/or proximity of the delivery vehicle 314. In some embodiments, the camera 310 is a wide-angle camera or a 360° camera that is configured to obtain a video or capture images of a large area proximal to the EVCS 302. The one or more cameras 310 may be mounted directly on the housing 304 of the EVCS 302 and may have a physical (e.g., electrical, wired) connection to the EVCS 302 or a computer system associated with the EVCS 302. In some embodiments, the one or more cameras 310 are mounted directly on the docking station 312 of the EVCS 302. In some embodiments, the one or more cameras 310 (or other sensors) are disposed separately from but proximal to the housing 304 of the EVCS 302. In some embodiments, the camera 310 is positioned at different locations on the EVCS 302 than what is shown. In some embodiments, the one or more cameras 310 include a plurality of cameras positioned at different locations on EVCS 302.

In some embodiments, the EVCS 302 further comprises one or more sensors (not shown). In some embodiments, the one or more sensors detect external objects (e.g., the delivery vehicle 314) within a region (area) proximal to the EVCS 302. In some embodiments, the area proximal to EVCS 302 includes one or more parking spaces, where electric vehicle's can park in order to use EVCS 302. In some embodiments, the area proximal to the EVCS 302 includes walking paths (e.g., sidewalks) next to the EVCS 302. In some embodiments, the one or more sensors are configured to determine a state of the area proximal to the EVCS 302 (e.g., wherein determining the state includes detecting external objects or the lack thereof). In some embodiments, the external objects are living or nonliving, such as people, animals, vehicles, shopping carts, toys, etc. In some embodiments, the one or more sensors detect stationary or moving external objects. In some embodiments, the one or more sensors are one or more image (e.g., optical) sensors (e.g., one or more cameras 310), ultrasound sensors, depth sensors, IR cameras, RGB cameras, PIR cameras, thermal IR, proximity sensors, radar, tension sensors, NFC sensors, and/or any combination thereof. The one or more sensors may be connected to the EVCS 302 or a computer system associated with the EVCS 302 via wired or wireless connections such as via a Wi-Fi connection, Bluetooth connection, and/or via the control circuitry housed within EVCS 302.

In some embodiments, the EVCS 302 further comprises one or more lights configured to provide predetermined illumination patterns indicating a status of the EVCS 302. In some embodiments, at least one of the one or more lights is configured to illuminate an area proximal to the EVCS 302 as a person approaches the area (e.g., a driver returning to a vehicle or a passenger exiting a vehicle that is parked in a parking space associated with the EVCS 302). In some embodiments, at least one of the one or more lights is configured to illuminate an area proximal to the EVCS 302 as the delivery vehicle 314 approaches or exits the area (e.g., the delivery vehicle returning to or exiting the docking station 312).

In some embodiments, docking station 312 is connected to the control circuitry of EVCS 302 via wires. In some embodiments, docking station 312 is added to the EVCS 302 after the EVCS 302's initial installation (e.g., via nails, soldering, screws, etc.). In some examples, the housing 304 is altered so that the docking station 312 can connect to the delivery vehicle 314. In some embodiments, the docking station 312 is included in the initial design of EVCS 302 and is included in the system during the initial installation. In some embodiments, docking station 312 includes a connection point to communicate with, charge, or stabilize the delivery vehicle 314. For example, this connection point may use plugs, socket-outlets, vehicle connectors, and vehicle inlets using electric vehicle charging standards (e.g., International Electrotechnical Commission (IEC) 62196-1, IEC 62196-2, IEC 62196-3, IEC 62196-4, and/or IEC 62196-6). The connection point may also utilize Universal Serial Bus (USB) and/or National Electrical Manufacturers Association (NEMA) connectors and ports. In some embodiments, the docking station 312 charges the delivery vehicle 314. In some embodiments, the docking station 312 charges a portable charge. The docking station 312 may use a wireless or wired connection to the removably connected delivery vehicle 314 to charge the delivery vehicle 314 or a portable charge (e.g., 212 of FIG. 2A). The docking station 312 may comprise control circuitry to send commands to the delivery vehicle 314. The docking station 312 may take different shapes and orientations based upon the design of the EVCS 302 and/or the type of delivery vehicle.

FIG. 3B illustrates a system 350 used for charging an electric vehicle and for delivering items comprising a docking station 358 and item compartment 360, in accordance with some embodiments of the disclosure. In some embodiments, FIG. 3B illustrates the EVCSs displayed in FIGS. 1 and 3A. In some embodiments, FIG. 3B displays additional views of EVCS 302 shown in FIG. 3A. In some embodiments, EVCS 352 also comprises housing 354, one or more displays 356, charging cable 362, charging cable holder 364, and one or more cameras 366.

In some embodiments, compartment 360 is attached externally. Compartment 360 may vary in size depending upon the design of the EVCS 352. In some embodiments, the EVCS 352 comprises multiple compartments 360. In some embodiments, there is a manual method (e.g., a key) for opening the compartment 360. In some embodiments, the compartment 360 comprises multiple hinged doors that open mechanically for access to the contents of the compartment 360. In some embodiments, the compartment 360 consists of a single hinged door to access the contents enclosed in the compartment 360. In some embodiments, a door may roll open and closed. For example, the compartment door may roll using a DC brushless motor into the EVCS housing 354 when the compartment is open. In some embodiments, the compartment 360 requires a user to provide an input to open the compartment (e.g., inputting a passcode, scanning a barcode displayed on a user device, biometrics, etc.). In some embodiments, the compartment 360 is physically separate from the EVCS housing 354 but communicates with the circuitry of the EVCS 352. For example, there may be a pedestal/locker compartment for delivered items available at a central position among a group of EVCS kiosks. In some embodiments, the pedestal/locker compartment communicates via wires or wireless signals (e.g., Bluetooth) with one or more EVCSs and/or user devices. In some embodiments, the compartment 360 is temperature controlled to allow for temperature-sensitive items (e.g., food, electronics, etc.). In some embodiments, the compartment 360 contains safety items (e.g., defibrillator, first aid kit, etc.) and/or repair items (e.g., tire jack, jumper cables, etc.). In some embodiments, the compartment 360 contains batteries. In some embodiments, the batteries are used as replacement batteries for electric scooters, electric bikes, etc. In some embodiments, the batteries stored in compartment 360 are charged and may be swapped for batteries with less charge.

FIG. 3C illustrates a system 370 used for charging an electric vehicle and for delivering items. The EVCS 372 comprises a docking station 378 and an item compartment 380, in accordance with some embodiments of the disclosure. In some embodiments, FIG. 3C illustrates the EVCSs displayed in FIGS. 1 and 3A-B. In some embodiments, EVCS 372 also comprises housing 374, one or more displays 376, charging cable 386, and one or more cameras 388.

In some embodiments, the one or more cameras 388 are used to determine whether the delivery vehicle 392 is within a first threshold distance. In some embodiments, other forms of sensors (e.g., ultrasound sensors, depth sensors, IR cameras, RGB cameras, PIR cameras, heat IR, proximity sensors, radar, tension sensors, NFC sensors, and/or any combination thereof) are used to determine if the delivery vehicle 392 is within the first threshold. In some embodiments, the first compartment door 382 or the second compartment door 384 opens, if the delivery vehicle 392 is within the first threshold.

In some embodiments, docking station 378 includes an enclosure 390 to store the delivery vehicle. The enclosure may be attached via hinges, may only appear when the delivery vehicle is present, etc. For example, the enclosure 390 may fold into itself or into the EVCS 372. In some embodiments, the docking station 378 differs depending on the delivery vehicle that is in use. For example, the docking station 378 may be at the top of the EVCS 372 when the delivery vehicle is an unmanned aerial vehicle. In some embodiments, the docking station 378 is attached at the base of the EVCS 372 for land-roving delivery vehicles.

In some embodiments, the compartment 380 opens and closes a first compartment door 382 via mechanized hinges. In some embodiments, once the delivery vehicle 392 comes within a first threshold distance, the compartment 380 unlocks so that the user can manually open the door 382. In some embodiments, the compartment 380 unlocks and the compartment door 382 opens for the user. For example, the compartment door 382 may be connected to the EVCS 372 using a first hinge and be actuated by a first motor housed within the EVCS 372. In some embodiments, the motor rotates the compartment door 382 about the first hinge resulting in the compartment door 382 opening or closing. In some embodiments, there is a handle on the compartment door 382.

In some embodiments, in addition to the first compartment door 382, the EVCS 372 has a second compartment door 384. In some embodiments, the second compartment door 384 opens when the second compartment door 384 slides into the EVCS 372. In some embodiments, the second compartment door 384 unlocks once the delivery vehicle 392 comes within a threshold distance. In some embodiments, after the second compartment door 384 unlocks, a user must manually open the compartment door. In some embodiments, the second compartment door 384 slides open and closed using a brushless DC motor or brushless DC gear motor (like those used in automatic sliding doors).

Compartment 380 may open automatically when receiving an item from a delivery vehicle but may require manual operation for the user to obtain the item delivered by the delivery vehicle. The compartment 380 may require an input to open the first compartment door 382 or the second compartment door 384. In some embodiments, a user uses the display 376 to input a credential (e.g., password) and open the compartment 380. In some embodiments, a user uses a user device (e.g., a smartphone) to input a credential (e.g., password) to collect an item from the compartment 380. In some embodiments, there are multiple compartments of multiple forms and/or sizes. For example, there may be one compartment for small items held within the EVCS 372 and one compartment for larger items located within a first distance (e.g., 10 feet) from the EVCS 372.

In some embodiments, EVCS 372 comprises an enclosure 390 to house the delivery vehicle 392. In some embodiments, enclosure 390 comprises walls of plastic around the perimeter of the docking station 378 to enclose the delivery vehicle 392. In some embodiments, enclosure 390 comprises a lid for the delivery vehicle enclosure 390 that opens and closes upon the entrance or exit of the delivery vehicle 392. In some embodiments, the delivery vehicle enclosure 390 retracts into the EVCS 372 when not in use. The delivery vehicle enclosure 390 may have security measures. For example, the delivery vehicle enclosure 390 can have a roof feature that locks into place via internal mechanized hooks when the delivery vehicle 392 is not in use. In some embodiments, the delivery vehicle enclosure 390 is lower on the EVCS 372 to accommodate different types of delivery vehicles (e.g., land-roving delivery vehicles). For example, a delivery vehicle enclosure 390 may include further methods to protect the delivery vehicle (e.g., connection points between the delivery vehicle 392 and the EVCS 372). The delivery vehicle enclosure 390 may work with the charging circuitry for the delivery vehicle, e.g., by sealing the enclosure while the delivery vehicle 392 charges. In some embodiments, upon sensing that the delivery vehicle 392, the enclosure 390 may lock in place over the vehicle. The docking station may sense the delivery vehicle 392 is within its enclosure 390 via wired or wireless connections, via a weight sensor, etc. In some embodiments, the delivery vehicle enclosure 390 protects the delivery vehicle 392 from extreme weather (e.g., snow, intense heat, rain, etc.). In some embodiments, the delivery vehicle enclosure 390 changes with the seasons either automatically or manually (e.g., by having a service worker service the EVCSs). In some embodiments, the enclosure has one or more holes (e.g., a half-inch diameter). In some embodiments, the one or more holes provide for ventilation during hot and/or humid months. In some embodiments, the one or more holes close via a motorized mechanism once the temperature drops below a predetermined threshold (e.g., 60 degrees Fahrenheit) or if extreme weather is detected.

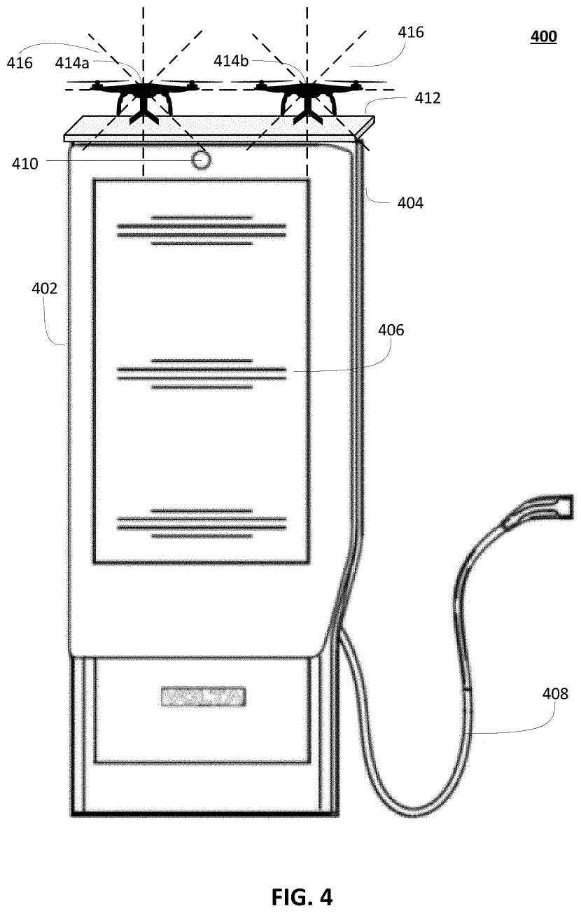

FIG. 4 illustrates another system 400 used for charging an electric vehicle and for delivering items, in accordance with some embodiments of the disclosure. In some embodiments, FIG. 4 illustrates the EVCS 102 displayed in FIG. 1. In some embodiments, EVCS 402 comprises housing 404, display 406, charging cable 408, camera(s) 410, and docking station 412, as described previously.

In some embodiments, the docking station 412 charges one or more delivery vehicles 414a-b. The one or more delivery vehicles 414a-b may be of the same type (e.g., two unmanned aerial vehicles), or may be of different types (e.g., with the first delivery vehicle 414a being a land-roving vehicle and the second delivery vehicle 414b being an aerial vehicle). In some embodiments, if there are multiple types of delivery vehicles 414a-b, there are different docking stations 412 for each. In some embodiments, both delivery vehicles 414a-b charge at the same docking station 412.

In some embodiments, EVCS 402 uses application programming interface (API) calls 416 to connect to one or more delivery vehicles 414a-b. The EVCS 402 may use API calls 416 to notify a passing delivery vehicle of the EVCS 402 location. The EVCS 402 may use API calls 416 to notify a first delivery vehicle 414a that the EVCS 402 is available for charging. For example, a delivery service using unmanned aerial vehicles (e.g., third-party service), may use the EVCS 402 as a charging station. Third-party delivery vehicles may have access to a database of available EVCS locations. In some embodiments, if an EVCS 402 detects that a delivery vehicle flies within a predetermined threshold of the EVCS 402, the EVCS 402 sends an API call indicating an available docking station 412 where the passing delivery vehicle can charge.

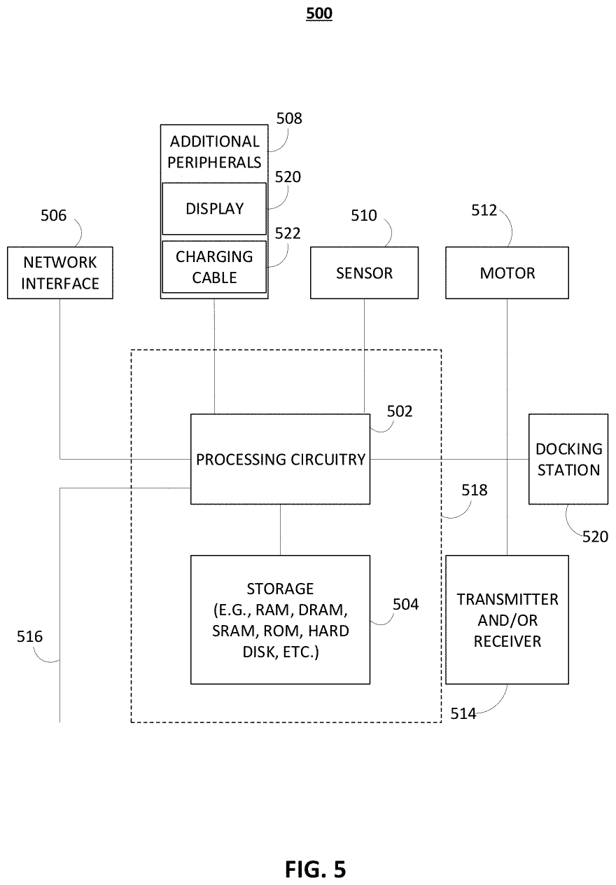

FIG. 5 shows an illustrative block diagram of an EVCS system 500, in accordance with some embodiments of the disclosure. EVCS system 500 of FIG. 5 may be any of the EVCSs depicted in FIGS. 1A-3C. In practice, and as recognized by those of ordinary skill in the art, items shown separately could be combined and some items could be separated. In some embodiments, not all shown items must be included in EVCS 500. In some embodiments, EVCS 500 comprises additional items.

The EVCS 500 can include processing circuitry 502 that includes one or more processing units (processors or cores), storage 504, one or more network or other communications network interfaces 506, additional peripherals 508, one or more sensors 510, a motor 512 (configured to retract a portion of the charging cables), one or more wireless transmitters and/or receivers 514, and one or more input/output I/O paths 516. I/O paths 516 may use communication buses for interconnecting the described components. I/O paths 516 can include circuitry (sometimes called a chipset) that interconnects and controls communications between the components of the EVCS 500. The EVCS 500 may receive content and data via I/O paths 516. The I/O path 516 may provide data to control circuitry 518, which includes processing circuitry 502 and a storage 504. The control circuitry 518 may be used to send and receive commands, requests, and other suitable data using the I/O path 516. The I/O path 516 may connect the control circuitry 518 (and specifically the processing circuitry 502) to one or more communications paths. I/O functions may be provided by one or more of these communications paths but are shown as a single path in FIG. 5 to avoid overcomplicating the drawing. The circuitry comprising EVCS 500 may connect to IoT devices in the area to increase the functionality or the ease of use of the delivery services.

The control circuitry 518 may be based on any suitable processing circuitry such as the processing circuitry 502. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry is distributed across multiple separate processors or processing units, for example, multiple of the same type of processing units (e.g., two Intel Core i7 processors) or multiple different processors (e.g., an Intel Core i5 processor and an Intel Core i7 processor). The delivery functionality can be at least partially implemented using the control circuitry 518. The delivery vehicle functionalities described herein may be implemented in or supported by any suitable software, hardware, or combination thereof. The delivery functionality can be implemented on user equipment, on remote servers, or across both.

The control circuitry 518 may include communications circuitry suitable for communicating with one or more servers. The instructions for carrying out the above-mentioned functionality may be stored on the one or more servers. Communications circuitry may include a cable modem, an integrated service digital network (ISDN) modem, a digital subscriber line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 504 that is part of the control circuitry 518. As referred to herein, the phrase “storage device” or “memory device” should be understood to mean any device for storing electronic data, computer software, or firmware, such as random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same. In some embodiments, the storage 504 includes one or more storage devices remotely located, such as database of server system that is in communication with EVCS 500. In some embodiments, the storage 504, or alternatively the non-volatile memory devices within the storage 504, includes a non-transitory computer-readable storage medium.

In some embodiments, the storage 504 or the computer-readable storage medium of the storage 504 stores an operating system, which includes procedures for handling various basic system services and for performing hardware dependent tasks. In some embodiments, the storage 504 or the computer-readable storage medium of the storage 504 stores a communications module, which is used for connecting EVCS 500 to other computers and devices via the one or more communication network interfaces 506 (wired or wireless), such as the internet, other wide area networks, local area networks, metropolitan area networks, and so on. In some embodiments, the storage 504 or the computer-readable storage medium of the storage 504 stores a media item module for selecting and/or displaying media items on the display(s) 520 to be viewed by passersby and users of EVCS 500. In some embodiments, the storage 504 or the computer-readable storage medium of the storage 504 stores an EVCS module for charging an electric vehicle (e.g., measuring how much charge has been delivered to an electric vehicle, commencing charging, ceasing charging, etc.), including a motor control module that includes one or more instructions for energizing or forgoing energizing the motor. In some embodiments, the storage 504 or computer-readable storage medium of the storage 504 stores an EVCS module for commanding a delivery vehicle connected. In some embodiments, executable modules, applications, or sets of procedures may be stored in one or more of the previously mentioned memory devices and corresponds to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 504 stores a subset of the modules and data structures identified above. In some embodiments, the storage 504 stores additional modules or data structures not described above.

In some embodiments, EVCS 500 comprises additional peripherals 508 such as displays 520 for displaying content and charging cable 522. In some embodiments, the displays 520 are touch-sensitive displays that are configured to detect various swipe gestures (e.g., continuous gestures in vertical and/or horizontal directions) and/or other gestures (e.g., a single or double tap) or to detect user input via a soft keyboard that is displayed when keyboard entry is needed.

In some embodiments, EVCS 500 comprises one or more sensors 510 such as cameras (e.g., camera, described above with respect to FIGS. 1, 3A, 3B, and/or 3C), ultrasound sensors, depth sensors, IR cameras, RGB cameras, PIR cameras, heat IR, proximity sensors, radar, tension sensors, NFC sensors, and/or any combination thereof. In some embodiments, the one or more sensors 510 detect whether external objects are within a region proximal to EVCS 500, such as living and nonliving objects (e.g., the delivery vehicle), and/or the status of EVCS 500 (e.g., available, occupied, etc.) in order to perform an operation, such as commanding a delivery vehicle to deliver a charge to a stranded vehicle, commanding a delivery vehicle to retrieve items, etc.

In some embodiments, EVCS 500 includes a docking station 520 for a delivery vehicle. This docking station 520 may include charging capabilities for the delivery vehicle. These charging capabilities may be wireless or wired, e.g., charging via a magnetic field, via a direct or alternating current charging cable, etc. The docking station 520 may allow for different delivery vehicles to use the EVCSs interchangeably, or delivery vehicles may be assigned specific EVCSs. The delivery vehicles may take the form of unmanned aerial vehicles (UAVs) (e.g., drones) or can take automated land-roving forms. The docking stations 520 may have the capability to determine if there is a delivery vehicle currently occupying the docking station 520. This determination may be made via detection by the charging cable, sensors 510 noting the docking station being occupied (e.g., through light detection sensors, weight sensors, Bluetooth sensors, 510), or a physical mechanism to help lock the delivery vehicle in place.

The EVCS server may determine a specific docking station to send out a delivery vehicle from. This decision may be determined by a module in the control circuitry 518 based on a plurality of factors (e.g., the stranded electric vehicle's distance from the charging station, the size of the charge needed for the electric vehicle to reach the EVCS, the distance to reach the pick-up location for an item purchased by an electric vehicle user, etc.). The docking station 520 may have a security system such that the docked delivery vehicle is protected from external factors (e.g., weather, thieves, or other possible causes of damage to the delivery vehicle). This protection may take the form of a physical mechanically attached covering, or some connection between the docking station 520 and the delivery vehicle, itself, regardless of charging method. There may be a locking mechanism attached to the delivery vehicle's charging apparatus that connects to the delivery vehicle while it is not in use. There may be a retractable mechanical feature to lock in the delivery vehicle. If a land-roaming automated delivery vehicle is in use, there may be a compartment that it is enclosed in when not in use. This docking station can be attached to the EVCS using a removably connected attachment applied to previously installed EVCSs or can be integrated into the design of the EVCS from first installation. If the docking station is attached after first installation, it may contain wiring and additional instructions to connect with the original control circuitry.

In some embodiments, the EVCS 500 comprises mechanical methods for storing the delivery vehicle, e.g., a shelf-like feature, an external compartment, etc., which may be attached using non-electric tools (e.g., screws) or electric tools (e.g., soldering irons, power tools) to more permanently affix the delivery vehicle's storage features. The docking station 520 may indicate what delivery vehicle it is housing (e.g., by determining in which compartment the delivery vehicle is being charged, its method of charging, by receiving signals indicating a unique identifier for the delivery vehicle, etc.). In some embodiments, the docking station 520 indicates the status of the delivery vehicle. This status may include the charge of the delivery vehicle (e.g., through a signal sent by the vehicle through the charging cable), a systems check of the vehicle, whether the vehicle is carrying anything (e.g., through weight sensors 510), which delivery vehicle it is (e.g., sent through a signal with a unique identifier), where it originated, etc.

In some embodiments, the docking station 520 charges the portable charge for the stranded electric vehicles. In some embodiments, the docking station 520 holds the items that an electric vehicle user asks to be delivered (e.g., if a user orders a small item like a wallet that fits in the compartment with the delivery vehicle). In some embodiments, docking stations 520 support different types of delivery vehicles (e.g., compartments on the ground for automated land-roving vehicles, shelves attached to the top of the EVCS for unmanned aerial vehicles, compartments on the side of the EVCS). Some embodiments include docking stations 520 with multiple charging methods to support different delivery vehicles that may switch EVCSs, and charging methods change over time (e.g., delivery vehicles may initially be best equipped to connect via a type-C charging cable but as delivery vehicle technology progresses, some new vehicles with wireless charging may need to have charging capabilities at the same docking station).

Some embodiments allow user interaction directly with the docking stations, whereas some embodiments only allow docking stations to interact with their circuitry (e.g., some stations have a designated keypad attached to a compartment holding the user's items, others require a user to use an application on their user device to access the compartment). Some embodiments have EVCS control circuitry 518 with the plugged-in electric vehicle to instigate action. Some embodiments equip a single EVCS with multiple docking stations wherein these docking stations hold the same or different types of vehicles (e.g., both UAVs and land-roving automated delivery vehicles). In some embodiments, EVCS docking stations 520 hold multiple delivery vehicles (e.g., the docking station 520 could hold two UAVs).

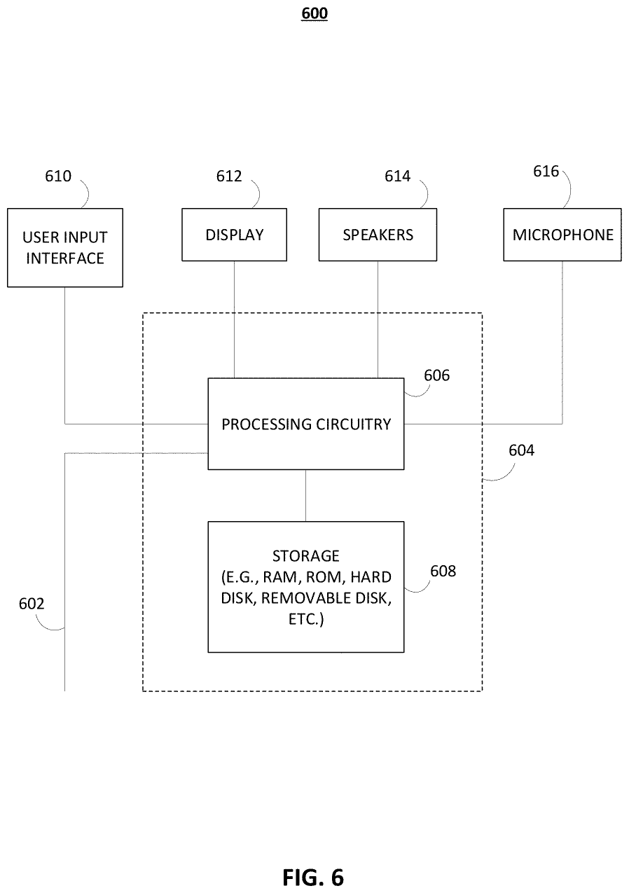

FIG. 6 shows an illustrative block diagram of a user equipment device system, in accordance with some embodiments of the disclosure. In practice, and as recognized by those of ordinary skill in the art, items shown separately could be combined and some items could be separated. In some embodiments, not all shown items must be included in device 600. In some embodiments, device 600 comprises additional items. In an embodiment, the user equipment device 600, is the same user equipment device displayed in FIG. 1. The user equipment device 600 may receive content and data via input/output I/O path 602. The I/O path 602 may provide audio content (e.g., broadcast programming, on-demand programming, Internet content, content available over a LAN or WAN, and/or other content) and data to control circuitry 604, which includes processing circuitry 606 and a storage 608. The control circuitry 604 may be used to send and receive commands, requests, and other suitable data using the I/O path 602. The I/O path 602 may connect the control circuitry 604 (and specifically the processing circuitry 606) to one or more communications paths. I/O functions may be provided by one or more of these communications paths but are shown as a single path in FIG. 6 to avoid overcomplicating the drawing.

The control circuitry 604 may be based on any suitable processing circuitry such as the processing circuitry 606. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry is distributed across multiple separate processors or processing units, for example, multiple of the same type of processing units (e.g., two Intel Core i7 processors) or multiple different processors (e.g., an Intel Core i5 processor and an Intel Core i7 processor).

In client-server-based embodiments, the control circuitry 604 may include communications circuitry suitable for communicating with one or more servers that may at least implement the described allocation of services functionality. The instructions for carrying out the above-mentioned functionality may be stored on the one or more servers. Communications circuitry may include a cable modem, an ISDN modem, a DSL modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 608 that is part of the control circuitry 604. Storage 608 may include random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum storage devices, gaming consoles, gaming media, or any other suitable fixed or removable storage devices, and/or any combination of the same. The storage 608 may be used to store various types of content described herein. Nonvolatile memory may also be used (e.g., to launch a boot-up routine and other instructions). Cloud-based storage may be used to supplement the storage 608 or instead of the storage 608.

The control circuitry 604 may include audio generating circuitry and tuning circuitry, such as one or more analog tuners, audio generation circuitry, filters or any other suitable tuning or audio circuits or combinations of such circuits. The control circuitry 604 may also include scaler circuitry for upconverting and down converting content into the preferred output format of the user equipment device 600. The control circuitry 604 may also include digital-to-analog converter circuitry and analog-to-digital converter circuitry for converting between digital and analog signals. The tuning and encoding circuitry may be used by the user equipment device 600 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 608 is provided as a separate device from the user equipment device 600, the tuning and encoding circuitry (including multiple tuners) may be associated with the storage 608.

The user may utter instructions to the control circuitry 604 which are received by the microphone 616. The microphone 616 may be any microphone (or microphones) capable of detecting human speech. The microphone 616 is connected to the processing circuitry 606 to transmit detected voice commands and other speech thereto for processing. In some embodiments, voice assistants (e.g., Siri, Alexa, Google Home, and similar such voice assistants) receive and process the voice commands and other speech.

The user equipment device 600 may optionally include an interface 610. The interface 610 may be any suitable user interface, such as a remote control, mouse, trackball, keypad, keyboard, touch screen, touchpad, stylus input, joystick, or other user input interfaces. A display 612 may be provided as a stand-alone device or integrated with other elements of the user equipment device 600. For example, the display 612 may be a touch screen or touch-sensitive display. In such circumstances, the interface 610 may be integrated with or combined with the microphone 616. When the interface 610 is configured with a screen, such a screen may be one or more of a monitor, a television, a liquid crystal display (LCD) for a mobile device, active matrix display, cathode ray tube display, light-emitting diode display, organic light-emitting diode display, quantum dot display, or any other suitable equipment for displaying visual images. In some embodiments, the interface 610 is HDTV-capable. In some embodiments, the display 612 is a 3D display. The speaker (or speakers) 614 may be provided as integrated with other elements of user equipment device 600 or may be a stand-alone unit. In some embodiments, the display 612 is outputted through speaker 614.

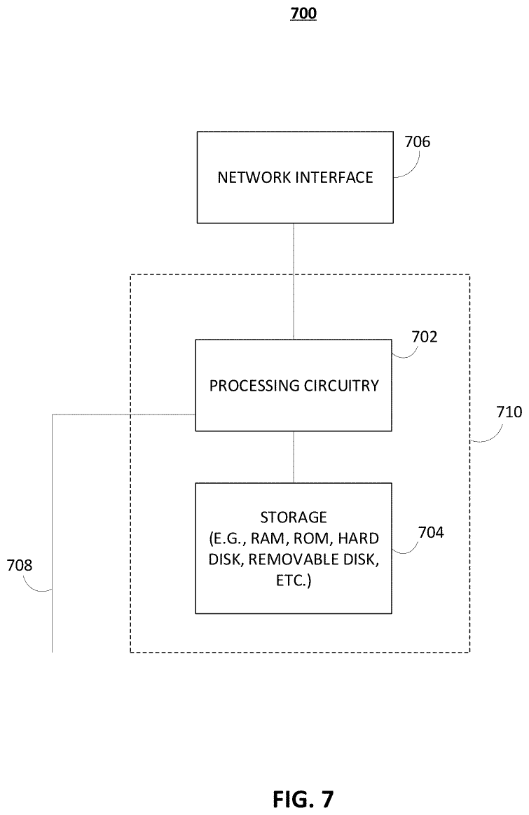

FIG. 7 shows an illustrative block diagram of a server system 700, in accordance with some embodiments of the disclosure. Server system 700 may include one or more computer systems (e.g., computing devices), such as a desktop computer, a laptop computer, and a tablet computer. In some embodiments, the server system 700 is a data server that hosts one or more databases (e.g., databases of images or videos), models, or modules or may provide various executable applications or modules. In practice, and as recognized by those of ordinary skill in the art, items shown separately could be combined and some items could be separated. In some embodiments, not all shown items must be included in server system 700. In some embodiments, server system 700 may comprise additional items.

The server system 700 can include processing circuitry 702 that includes one or more processing units (processors or cores), storage 704, one or more network or other communications network interfaces 706, and one or more input/output I/O paths 708. I/O paths 708 may use communication buses for interconnecting the described components. I/O paths 708 can include circuitry (sometimes called a chipset) that interconnects and controls communications between system components. Server system 700 may receive content and data via I/O paths 708. The I/O path 708 may provide data to control circuitry 710, which includes processing circuitry 702 and a storage 704. The control circuitry 710 may be used to send and receive commands, requests, and other suitable data using the I/O path 708. The I/O path 708 may connect the control circuitry 710 (and specifically the processing circuitry 702) to one or more communications paths. I/O functions may be provided by one or more of these communications paths but are shown as a single path in FIG. 7 to avoid overcomplicating the drawing.

The control circuitry 710 may be based on any suitable processing circuitry such as the processing circuitry 702. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry is distributed across multiple separate processors or processing units, for example, multiple of the same type of processing units (e.g., two Intel Core i7 processors) or multiple different processors (e.g., an Intel Core i5 processor and an Intel Core i7 processor).

Memory may be an electronic storage device provided as the storage 704 that is part of the control circuitry 710. Storage 704 may include random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same.

In some embodiments, storage 704 or the computer-readable storage medium of the storage 704 stores an operating system, which includes procedures for handling various basic system services and for performing hardware dependent tasks. In some embodiments, storage 704 or the computer-readable storage medium of the storage 704 stores a communications module, which is used for connecting the server system 700 to other computers and devices via the one or more communication network interfaces 706 (wired or wireless), such as the internet, other wide area networks, local area networks, metropolitan area networks, and so on. In some embodiments, storage 704 or the computer-readable storage medium of the storage 704 stores a web browser (or other application capable of displaying web pages), which enables a user to communicate over a network with remote computers or devices. In some embodiments, storage 704 or the computer-readable storage medium of the storage 704 stores a database for storing information on electric vehicle charging stations, their locations, media items displayed at respective electric vehicle charging stations, a number of each type of impression count associated with respective electric vehicle charging stations, user profiles, and so forth.

In some embodiments, executable modules, applications, or sets of procedures are stored in one or more of the previously mentioned memory devices and corresponds to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 704 stores a subset of the modules and data structures identified above. In some embodiments, the storage 704 stores additional modules or data structures not described above.

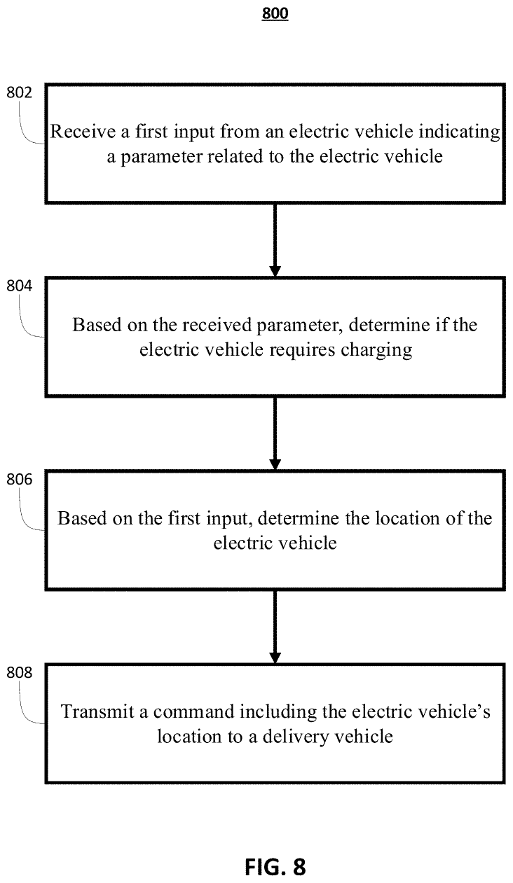

FIG. 8 shows an illustrative flowchart of a process for delivering items to an electric vehicle using an EVCS system, in accordance with some embodiments of the disclosure. Process 800 may be performed by physical or virtual control circuitry, such as control circuitry 518 of EVCS 500 (FIG. 5). In some embodiments, some steps of process 800 are performed by one of several devices.

At step 802, the control circuitry receives a first input from an electric vehicle indicating a parameter related to the electric vehicle. In some embodiments, the control circuitry receives the input from an electric vehicle and/or a user device associated with the electric vehicle. In some embodiments, the control circuitry receives the input via an API call, a cellular network, a radio wave, etc. In some embodiments, the first input is a charge delivery request. In some embodiments, the first input includes a parameter. In some embodiments, the parameter includes, e.g., a battery level of the electric vehicle, the location of the electric vehicle, the vehicle model, a type of charge requested, and/or other such information.

At step 804, the control circuitry determines whether the electric vehicle requires charging based on the received parameter. In some embodiments, a single parameter indicates the need for charging. For example, if the first input indicates that a battery level of an electric vehicle is below a threshold (e.g., less than 1%), the control circuitry determines that the electric vehicle requires charging. In some embodiments, multiple parameters are used to determine if charging is required. For example, a first parameter may indicate that the battery level is 2% charged and a second parameter may indicate that the electric vehicle is five miles away from an EVCS. The control circuitry can determine the electric vehicle requires charging if the battery level at 2% (first parameter) does not allow the electric vehicle to travel five miles to the nearest EVCS (second parameter). In some embodiments, the type of vehicle (parameter) is used to determine if the vehicle requires charging. For example, the amount of charge required for a larger electric vehicle (e.g., a sport utility vehicle) to travel a certain distance is larger than the amount of charge required for a smaller electric vehicle (e.g. a sedan) to travel the same distance. In some embodiments, the average miles-per-charge to expect (parameter) for an electric vehicle may determine if a vehicle requires charging. In some embodiments, the control circuitry weights different parameters according to significance when determining if the electric vehicle requires charging.

In some embodiments, the control circuitry can use additional information to determine if a vehicle requires charging. For example, an electric vehicle in stop-and-start traffic usually requires more charge than an electric vehicle in no traffic. In some embodiments, the control circuitry can receive additional information (e.g., traffic information) from the first input and/or a database. In some embodiments, the control circuitry uses the one or more parameters and additional information to determine if the electric vehicle requires charging.

In some embodiments, if the control circuitry determines that the electric vehicle requires charging, the control circuitry also determines charge characteristics (e.g., charge type, charge time, return instructions, etc.). In some embodiments, the control circuitry uses the one or more parameters and/or additional information described above to determine the charge characteristics. For example, if a first parameter indicates that a battery of the electric vehicle is 0% charge, the control circuitry may determine that a first portable charge (e.g., 1 kWh) is required instead of a second portable charge (0.5 kWh). In some embodiments, the control circuitry selects a delivery vehicle based on one or more charge characteristics. For example, a larger charge may require a delivery vehicle that can carry more weight, whereas a smaller charge can be delivered by a smaller delivery vehicle.

At step 806, the control circuitry determines the vehicle's location using the first input. In some embodiments, the vehicle's location can be determined using coordinates included in the first input. For example, the electric vehicle can determine a location using a Global Positioning System (GPS) and include the location into the first input. In another example, a user device associated with the electric vehicle can use a GPS to include the location into the first input. In some embodiments, the first input is one or more data packets comprising one or more fields, wherein one or more fields include the location. In some embodiments, the location is included in metadata associated with the first input. In some embodiments, the location of the electric vehicle helps determine the type of portable charge and/or type of delivery vehicle to send to the electric vehicle (e.g., an electric vehicle five miles away may need more charge than an electric vehicle that is only two miles away). The delivery vehicle may use different methods to arrive at the location of the electric vehicle, e.g., land-roving or flying to meet the electric vehicle. The path of the delivery vehicle may vary dependent upon the type of delivery vehicle, time of day, traffic, etc. In some embodiments, the location affects the determination made in step 804.

At step 808, the control circuitry transmits a command, including the electric vehicle's location, to the delivery vehicle. In some embodiments, the command comprises the type of charge to deliver to the electric vehicle. In some embodiments, the command comprises the method of delivery of the charge (e.g., to drop the charge, to connect to the electric vehicle, etc.). The command may include return instructions for the delivery vehicle (e.g., return flight directions, instructions indicating that the user will transport the delivery vehicle back to the EVCS, etc.). In some embodiments, the command includes user requirements. For example, the delivery vehicle may require a credential, a payment, etc., before releasing the portable charge. In some embodiments, the control circuitry transmits the command to the delivery vehicle via a wired connection (e.g., the same connection used to charge the delivery vehicle). In some embodiments, the control circuitry transmits the command via Bluetooth, API calls, etc.

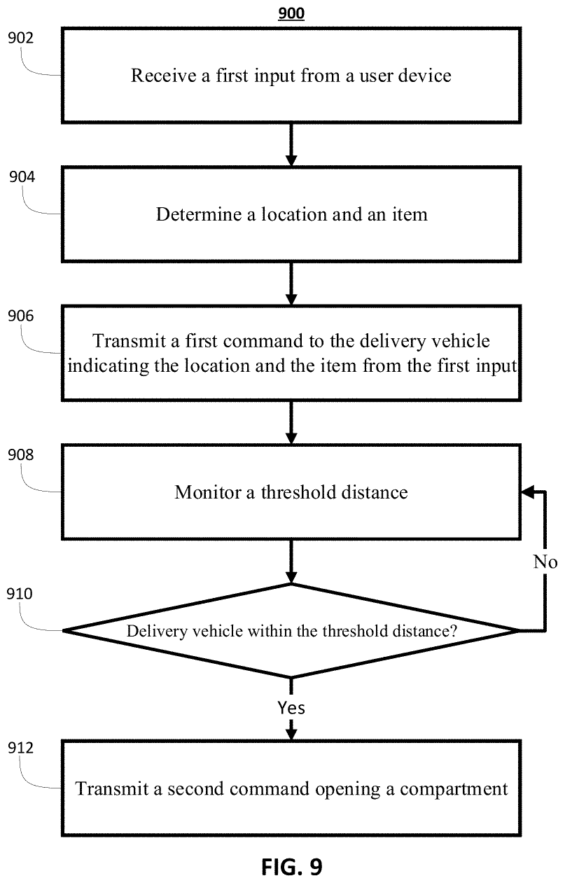

FIG. 9 depicts another illustrative flowchart of a process for delivering items to a vehicle using an EVCS, in accordance with some embodiments of the disclosure. In some embodiments, the location from which the delivery vehicle is retrieving the item is near the EVCS. In some embodiments, a delivery vehicle is removably connected to the EVCS and may obtain one or more items from a location to deliver to the EVCS.

At step 902, control circuitry receives a first input from a user device. The user of the user device may have a vehicle connected to an EVCS. In some embodiments, a delivery vehicle is removably connected to the EVCS via a docking station. In some embodiments, the user submits the first input from within their electric vehicle that is charging at the EVCS. In some embodiments, the first input comprises a delivery request. For example, a user may purchase a candle from a first location (e.g., shopping center) and submit a delivery request to a delivery vehicle. The first input may be transmitted from the user device using USB cables, IEEE 1394 cables, wireless paths (e.g., Bluetooth, infrared, IEEE 802-11x, etc.), other short-range communication via wired or wireless paths, and/or similar such methods. In some embodiments, the first input may be transmitted using the Internet, a mobile phone network, mobile voice or data network (e.g., a 4G, 5G, or LTE network), cable network, public switched telephone network, or other types of communications networks or combinations of communications networks.

At step 904, the control circuitry determines an item and a location from the first input. In some embodiments, the first input is one or more data packets comprising one or more fields, wherein one or more fields include a location and/or an item. In some embodiments, the location and/or item is included in metadata associated with the first input. For example, the first input may include a user purchase of a houseware (item) from a shopping center (location). In some embodiments, the first input may indicate more than one item and more than one location. For example, the user may purchase items from more than one location and requests delivery of the items from the more than one location.

At step 906, the control circuitry transmits a first command to the delivery vehicle. In some embodiments, the command includes the location and item determined in step 904. In some embodiments, the first command is transmitted by USB cables, IEEE 1394 cables, wireless paths (e.g., Bluetooth, infrared, IEEE 802-11x, etc.), or other short-range communication via wired or wireless paths. In some embodiments, the first command is transmitted using the Internet, a mobile phone network, mobile voice or data network (e.g., a 4G, 5G, or LTE network), cable network, public switched telephone network, or other types of communications networks or combinations of communications networks. In some embodiments, the delivery vehicle receives the first command causing the delivery vehicle to travel to a first location associated with the first command. In some embodiments, the delivery vehicle receives additional commands as the delivery vehicle travels to the first location. For example, the delivery vehicle may be going to a first location to pick up a first item and receive a second command to go to a second location to pick up a second item. In some embodiments, the delivery vehicle will optimize the pickup/delivery route. For example, after receiving a second command, the delivery vehicle may queue the first command and travel to a second location associated with the second command to avoid unnecessary travel. In some embodiments, the control circuitry indicates a first route for the delivery vehicle in the first command and then receives an addition input (e.g., a second delivery request). The control circuitry can determine a second route that comprises the first location corresponding to the first input and the second location corresponding to a second input and transmit the second route to the delivery vehicle using the second command. In some embodiments, the first command requests reports from the delivery vehicle, e.g., the delivery vehicle's location, the delivery vehicle's receipt of the item, any errors during the delivery process, etc.

At step 908, the control circuitry monitors a threshold distance. In some embodiments, the threshold distance represents an area around the EVCS. In some embodiments, the EVCS monitors the threshold distance using sensors or cameras connected to the EVCS. For example, these sensors may be image (e.g., optical) sensors, ultrasound sensors, depth sensors, IR cameras, RGB cameras, PIR cameras, heat IR, proximity sensors, radar, tension sensors, NFC sensors, and/or any combination thereof. In some embodiments, one or more cameras are configured to capture one or more images of an area proximal to the EVCS. In some embodiments, the threshold distance relies upon the type of delivery vehicle in use. For example, a larger threshold distance (e.g., 10 feet) may be used for unmanned aerial vehicle and a smaller threshold distance (e.g., five feet) may be used for land-roving delivery vehicles. In some embodiments, step 908 begins after a delivery vehicle leaves the EVCS. In some embodiments, step 908 begins after a first estimated timeframe. In some embodiments, the first estimated timeframe is the approximate amount of time for the delivery vehicle to retrieve the item. For example, if the delivery vehicle must travel 20 minutes to pick up the item and return to the EVCS, the control circuitry may begin step 908 20 minutes after the delivery vehicle's departure.

At step 910, control circuitry determines whether the delivery vehicle is within the threshold distance. If the delivery vehicle is not within the threshold distance, the process 900 proceeds to step 908. If the control circuitry determines that the delivery vehicle is within the threshold distance, the process 900 proceeds to step 912.

At step 912, in response to determining that the delivery vehicle is within a threshold distance, the control circuitry transmits a second command opening a compartment. In some embodiments, the compartment holds the delivery vehicle and the delivered item(s). In some embodiments, the compartment is part of the EVCS (e.g., compartment 360 of FIG. 3B). In some embodiments, the compartment is separate from the EVCS (e.g., a housing at a central location). In some embodiments, the control circuitry transmits multiple commands to open more than one compartment, e.g., a first compartment for the item and a second compartment for the delivery vehicle. In some embodiments, the compartments vary in size and opening mechanisms. In some embodiments, the second command is transmitted using USB cables, IEEE 1394 cables, wireless paths (e.g., Bluetooth, infrared, IEEE 802-11x, etc.), other short-range communication via wired or wireless paths, etc. In some embodiments, the second command is transmitted using the Internet, a mobile phone network, mobile voice or data network (e.g., a 4G, 5G, or LTE network), cable network, public switched telephone network, or other types of communications networks or combinations of communications networks.

It is contemplated that some suitable steps or suitable descriptions of FIGS. 8-9 may be used with other suitable embodiments of this disclosure. In addition, some suitable steps and descriptions described in relation to FIGS. 8-9 may be implemented in alternative orders or in parallel to further the purposes of this disclosure. For example, some suitable steps may be performed in any order or in parallel or substantially simultaneously to reduce lag or increase the speed of the system or method. Some suitable steps may also be skipped or omitted from the process. Furthermore, it should be noted that some suitable devices or equipment discussed in relation to FIGS. 1-7 could be used to perform one or more of the steps in FIGS. 8-9.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. An electric vehicle charging station system comprising:
an electric vehicle charging station;
a delivery vehicle, removably coupled to the electric vehicle charging station;
a communication system, wherein the communication system comprises:
a first connection point, wherein the first connection point is configured to removably connect an electric vehicle to the electric vehicle charging station;
a second connection point, wherein the second connection point is configured to removably connect the delivery vehicle to the electric vehicle charging station; and
a receiver, wherein the receiver is configured to receive a first input from the electric vehicle, wherein the first input indicates a parameter related to the electric vehicle; and
control circuitry, wherein the control circuitry is configured to:
determine, based on the parameter indicated by the first input, that the electric vehicle requires charging;
determine, based on the received input, the location of the electric vehicle; and
transmit a command using the second connection point, to the delivery vehicle, wherein the command indicates the location of the electric vehicle.

2. The electric vehicle charging station system of claim 1, wherein the delivery vehicle comprises:
a first rotor; and
a navigation system configured to:
receive the command from the electric vehicle charging station; and
navigate, using the first rotor, to the determined location.

3. The electric vehicle charging station system of claim 1, wherein the delivery vehicle comprises:
a movement system comprising one or more wheels; and
a navigation system configured to:
receive the command from the electric vehicle charging station; and
navigate, using the movement system, to the determined location.

4. The electric vehicle charging station system of claim 1, wherein the delivery vehicle is an aerial vehicle.

5. The electric vehicle charging station system of claim 1, wherein the delivery vehicle is a land-roving vehicle.

6. The electric vehicle charging station system of claim 1 wherein the received parameter relates to the battery level of the electric vehicle being below a first threshold.

7. The electric vehicle charging station system of claim 1 wherein the control circuitry is further configured to:
transmit a notification to a user device associated with the electric vehicle.

8. The electric vehicle charging station system of claim 7 wherein the notification contains a departure time of the delivery vehicle, an anticipated arrival time of the delivery vehicle, and/or a price of the delivery service.

9. The electric vehicle charging station system of claim 1, wherein the control circuitry is further configured to charge the delivery vehicle, using the second connection point.

10. An electric vehicle charging station system comprising:
an electric vehicle charging station, wherein a first compartment is located within the electric vehicle charging station;
a delivery vehicle, removably coupled to the electric vehicle charging station;
a communication system, wherein the communication system comprises:
a first connection point, wherein the first connection point is configured to removably connect an electric vehicle to the electric vehicle charging station;
a second connection point, wherein the second connection point is configured to removably connect the delivery vehicle to the electric vehicle charging station; and
a receiver, wherein the receiver is configured to receive a first input from a user device; and
control circuitry, wherein the control circuitry is configured to:
determine a location and an item from the first input;
transmit a first command using the second connection point, to the delivery vehicle, wherein the first command indicates the location and the item determined from the first input;
determine that the delivery vehicle is within a threshold distance of the electric vehicle charging station; and
in respond to determining that the delivery vehicle is within a threshold distance, generate a second command, wherein the second command opens the first compartment.

11. The electric vehicle charging station system of claim 10, wherein the delivery vehicle is an aerial vehicle.

12. The electric vehicle charging station system of claim 10, wherein the delivery vehicle is a land-roving vehicle.

13. The electric vehicle charging station system of claim 10, wherein the control circuitry is further configured to monitor the position of the delivery vehicle.

14. The electric vehicle charging station system of claim 10, wherein the control circuitry is further configured to:
receive a second input from the user; and
in response to the second input, open the first compartment.
